(19) United States
(12) Patent Application Publication
(10) Pub. No.: US 2023/0226736 A1
(43) Pub. Date: Jul. 20, 2023

(54) Method of Recycling Waste and Product Make by the Same

(71) Applicant: Chih-Kun Tung, Taichung City (TW)

(72) Inventor: Chih-Kun Tung, Taichung City (TW)

(21) Appl. No.: 18/153,517

(22) Filed: Jan. 12, 2023

(30) Foreign Application Priority Data
Jan. 18, 2022 (TW) 111101922

(51) Int. Cl. B29C 48/275; B29C 48/00; B29C 48/88; B29C 48/80; E04C 3/28

(52) U.S. Cl. CPC B29C 48/277; B29C 48/022; B29C 48/911; B29C 48/802; E04C 3/28; B29K 2995/0097; B29K 2105/26

(57) ABSTRACT

A method of making recyclable waste contains steps of: a step of collecting so that the recyclable waste is collected and classified to industrial waste and daily use plastic; a step of crushing so that the industrial waste is crushed into granules, and the daily use plastic is made to raw materials; a step of mixing so that the granules and the raw material are mixed in a weight ratio; a step of heating and plasticizing so that the granules and the raw materials are maintained in a temperature to obtain plasticity in a flowing speed; a step of extruding so that the granules and the raw materials are extruded in a predetermined shape and a predetermined length, thus forming a body. Furthermore, the method further contains a step of cooling so that the body is cooled to solidify and to be make a recycled green building material.

### TECHNICAL FIELD

The present invention relates to a recycled green building material, and more particularly to a method of recycling waste and a product make by the same.

### BACKGROUND

Conventional pallets are made of trees, which are easily rotted after being exposed to the sun and rain, and the unusable pallets are thrown into the garbage dump and become part of the waste.

A large amount of waste is generated every day, becoming a source of environmental pollution. These wastes are recycled and produced into building materials through a recycling process, which complies with the principles of waste reduction (Reduce), reuse (Reuse) and recycling (Recycle), and is called “recycled green building materials”.

In addition to the effective use of recycled materials, green building materials also have the purpose of “guaranteeing the basic performance of building materials”, “not causing secondary pollution” and “not having adverse effects on human health”. Under the premise of maintaining the basic functions of building materials, increase the recycling rate and use compliant waste, avoid excessive addition of chemical substances such as adhesives or coating materials in the recycling process, and take into account performance, health, and ecological requirements

The present invention has arisen to mitigate and/or obviate the afore-described disadvantages.

### SUMMARY

The primary aspect of the present invention is to provide a method of recycling a waste to make green building material which has a certain hardness, a wear-resistance, a stiffness, and a ductility.

To obtain the above-mentioned aspects, a method of recycling a waste provided by the present invention contains steps of:

a step of collecting, wherein the recyclable waste is collected and classified to industrial waste and daily use plastic;

a step of crushing, wherein the industrial waste is crushed into granules, and the daily use plastic is made to raw materials;

a step of mixing, wherein the granules and the raw material are mixed and stirred in a weight ratio;

a step of heating and plasticizing, wherein the granules and the raw materials are maintained in a temperature to obtain plasticity in a flowing speed;

a step of extruding, wherein the granules and the raw materials are extruded in a predetermined shape and a predetermined length, thus forming a body; and

a step of cooling, wherein the body is cooled to solidify and to be make a recycled green building material.

### BRIEF DESCRIPTION OF THE DRAWINGS

FIG. 1 is a schematic view showing the steps of making a recycled green building material which is made of recyclable waste according to a preferred embodiment of the present invention.

FIG. 2 is a perspective view showing the assembly of the partition wall made by the method according to the preferred embodiment of the present invention.

FIG. 3 is a cross sectional view showing the assembly of the partition wall according to the preferred embodiment of the present invention.

FIG. 4 is a perspective view showing the application of the method of recycling a waste to make the recycled green building material according to the preferred embodiment of the present invention.

FIG. 5 is another perspective view showing the application of the method of recycling the waste to make the recycled green building material according to the preferred embodiment of the present invention.

FIG. 6 is also another perspective view showing the application of the method of recycling the waste to make the recycled green building material according to the preferred embodiment of the present invention.

FIG. 7 is still another perspective view showing the application of the method of recycling the waste to make the recycled green building material according to the preferred embodiment of the present invention.

### DETAILED DESCRIPTION

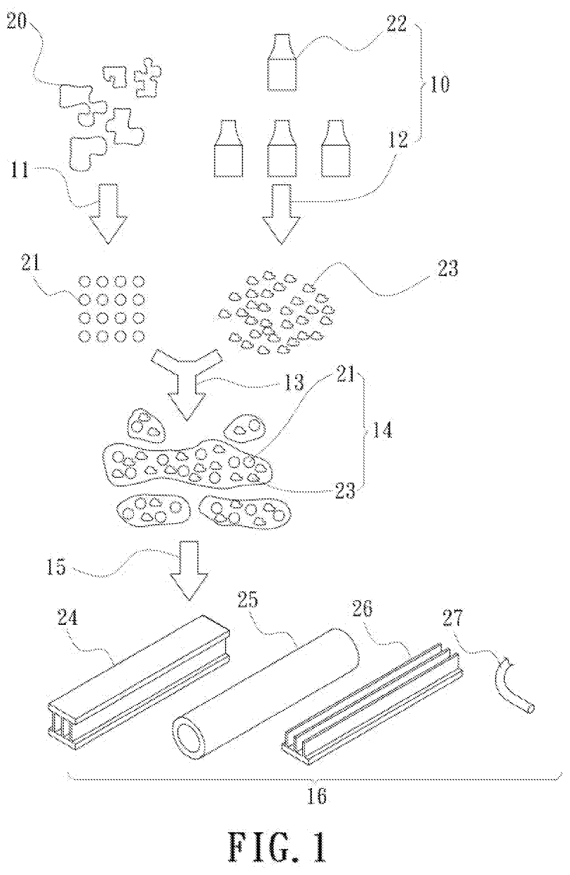

With reference to FIG. 1, a recycled green building material (such as a pallet) according to a preferred embodiment of the present invention is made in a step 10 of collecting, a step 11 of crushing, a step 12 of manufacturing, a step 13 of mixing, a step 14 of heating and plasticizing, a step 15 of extruding, and the other steps, such that a recyclable waste is used repeatedly, thus making the recycled green building material (such as the pallet) with a certain hardness, a wear-resistance, a stiffness, and a ductility.

In the step 10 of collecting, the recyclable waste is collected and classified to industrial waste 20 and daily use plastic 22.

The industrial waste 20 are any one of electronic waste, waste glass, wood chips, metal fines, thermoset plastics, thermoplastics, rubber, wood, fine copper, aluminum, tin, stainless steel, iron, and discarded furniture. The industrial waste 20 is crushed in the step 11 of crushing by using a cutting machine or a crushing device, wherein the industrial waste 20 is crushed into granules 21 with a diameter of 0.1 mm to 0.5 mm.

In the step 12 of manufacturing, the daily use plastic 22 is produced in a temperature of less than 100° C. and is any one of polyethylene (PE), polyproylene (PP), polystyrene (PS), styrene-acrylonitrile resin (SAN), polymethylmethacrylate (PMMA), polyvinyl chloride (PVC), acrylonitrile butadiene styrene (ABS) or shell bags. The daily use plastic 22 is washed, cut, and hot melted, thus making raw materials 23 from the daily use plastic 22.

In the step 13 of mixing, the granules 21 and the raw materials 23 are mixed and stirred, wherein 55 wt % granules 21 and 45 wt % raw materials 23 are mixed. In another embodiment, 75 wt % granules 21 and 25 wt % raw materials 23 are mixed. In other words, a weight ratio of the granules 21 is within 55 wt % to 75 wt %, and a weight ratio of the raw materials 23 is within 25 wt % to 45 wt %.

In the step 14 of heating and plasticizing, the granules 21 and the raw materials 23 are maintained in a temperature of at least 110° C. so as to obtain plasticity in a flowing speed to the granules 21 and the raw materials 23 which are heat melted.

In the step 15 of extruding, the granules 21 and the raw materials 23 are extruded in a predetermined shape and in a predetermined length, thus forming a body 31 by using a fixture or mold, as shown in FIG. 3.

In a step of cooling 16, the body 31 is cooled to solidify and to be make the recycled green building material.

The recycled green building material is a stem slab 24, a tube 25, and a profiled bar 26 or a wire 27.

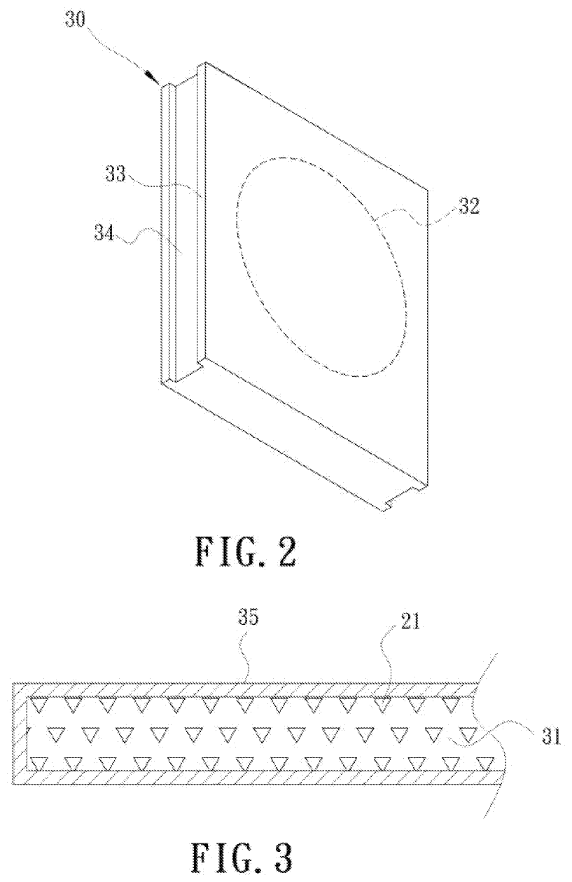

Referring to FIG. 2, a partition wall 30 is made of the recycled green building material, such as a stein slab 24. The partition wall 30 includes two ribs 33 formed on two sides thereof, and a respective one of the two ribs 33 has a groove, wherein at least one pattern 32 are formed on at least one surface the partition wall 30.

As shown in FIG. 3, the partition wall 30 includes a body 31 and an outer layer 35 covered on the body 31, wherein the outer layer 35 is made of thermoplastic and has a thickness of 2 mm to 5 mm, and the partition wall 30 is made of the recycled green building material, such as a stein slab.

The body 31 is made of the daily use plastic consisting of 55% to 75% industrial waste and 25% to 45% daily use plastic, and the outer layer 35 having a thickness of 2 mm to 5 mm covers the body 31, thus producing the recycled green building material with a hardness, a wear-resistance, a stiffness, and a ductility.

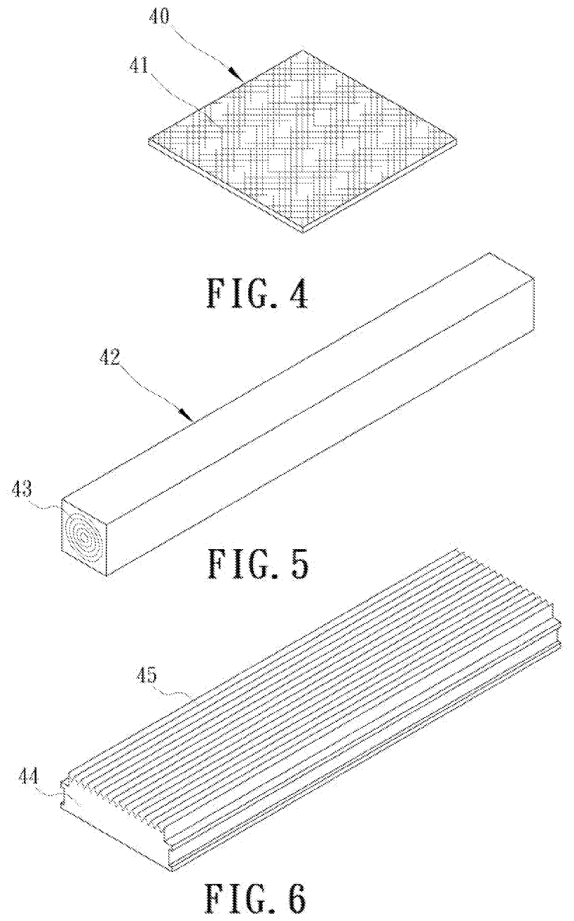

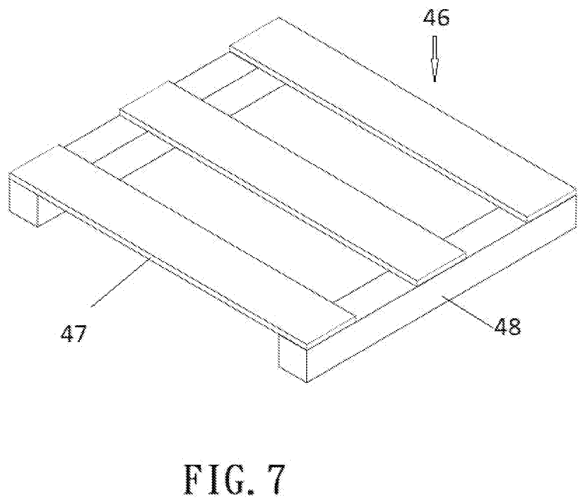

Preferably, the recycled green building material is any one of brick 40 with patterns 41 (as shown in FIG. 4), a column 42 with imitation wood texture 43 (as illustrated in FIG. 5), an exterior wall panel 44 with an declaration face 45 (as shown in FIG. 6), and a pallet 46 which includes three roofs 47 and two posts 48 (as illustrated in FIG. 7).

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A method of recycling waste comprising steps of:
a step of collecting, wherein the recyclable waste is collected and classified to industrial waste and daily use plastic;
a step of crushing, wherein the industrial waste is crushed into granules, and the daily use plastic is made to raw materials;
a step of mixing, wherein the granules and the raw material are mixed and stirred in a weight ratio;
a step of heating and plasticizing, wherein the granules and the raw materials are maintained in a temperature to obtain plasticity in a flowing speed;
a step of extruding, wherein the granules and the raw materials are extruded in a predetermined shape and a predetermined length, thus forming a body; and
a step of cooling, wherein the body is cooled to solidify and to be make a recycled green building material.

2. The method as claimed in claim 1, wherein in the step of mixing, 55 wt % to 75 wt % granules and 25 wt % to 45 wt % raw materials are mixed and stirred.

3. The method as claimed in claim 1, wherein an outer layer is covered on the body and is made of thermoplastic, wherein the outer layer has a thickness of 2 mm to 5 mm.

4. The method as claimed in claim 2, wherein an outer layer is covered on the body and is made of thermoplastic, wherein the outer layer has a thickness of 2 mm to 5 mm.

5. A recycled green building material made by the claim 1, wherein the body is made of the daily use plastic consisting of 55% to 75% industrial waste and 25% to 45% daily use plastic, and an outer layer is covered the body and has a thickness of 2 mm to 5 mm.

6. A recycled green building material made by the claim 2, wherein the body is made of the daily use plastic consisting of 55% to 75% industrial waste and 25% to 45% daily use plastic, and an outer layer is covered the body and has a thickness of 2 mm to 5 mm.

7. A recycled green building material made by the claim 3, wherein the body is made of the daily use plastic consisting of 55% to 75% industrial waste and 25% to 45% daily use plastic, and the outer layer has a thickness of 2 mm to 5 mm.

8. A recycled green building material made by the claim 4, wherein the body is made of the daily use plastic consisting of 55% to 75% industrial waste and 25% to 45% daily use plastic, and the outer layer has a thickness of 2 mm to 5 mm.

9. The method as claimed in claim 1, wherein the granules and the raw materials are maintained in a temperature of at least 110° C.
